(19) United States
(12) Patent Application Publication
(10) Pub. No.: US 2012/0064207 A1
(43) Pub. Date: Mar. 15, 2012

(54) FOOD COOKING METHOD AND DEVICE, AND FOOD MADE USING THE METHOD

(76) Inventors: Chang Gun SHIN, Daejeon (KR); Yi Seul SHIN, Daejeon (KR)

(21) Appl. No.: 13/283,717

(22) Filed: Oct. 28, 2011

Related U.S. Application Data
(63) Continuation of application No. PCT/KR2010/002285, filed on Apr. 14, 2010.

(30) Foreign Application Priority Data
Apr. 28, 2009 (KR) 10-2009-0037096

(51) Int. Cl. A23L 1/232; A47J 27/00; A23L 1/182; A23L 1/20; A23L 1/01; A23L 1/0522

(52) U.S. Cl. 426/314; 426/578; 426/618; 426/634; 99/352

(57) ABSTRACT

A food cooking method and a device in which a combustion chamber and a food cooking vessel are separated by a surface having fine holes or slits, and a fuel or a substance which gives off an aroma produced in the combustion chamber while the combustion chamber is screened from the atmosphere, such that heat and aroma are transmitted to the food as the aromatic and hot combustion gasses are discharged to the exterior through the food in the food cooking vessel. In the cooking method, flavor is enhanced as a smoky aroma is directly added to the foods in forms of pastes and the foods in a solid phase which is distributed by mixing into a liquid phase or semi-liquid phase. The method also can be used to remove unwanted smells and to cook rice.

### REFERENCE TO RELATED APPLICATIONS

This is a continuation of pending International Patent Application PCT/KR2010/002285 filed on Apr. 14, 2010, which designates the United States and claims priority of Korean Patent Application No. 10-2009-0037096 filed on Apr. 28, 2009, the entire contents of which are incorporated herein by reference.

### FIELD OF THE INVENTION

The present invention relates to a method and device for cooking food and food manufactured using the method, and more particularly, to a method and device for cooking food, and food manufactured using the method that can enhance a thermal efficiency upon heating cooking and that can simultaneously exhibit an effect of heating and smoking according to a case.

### BACKGROUND OF THE INVENTION

A heating cooking method is widely used as a method of cooking food. The heating cooking method is classified into several methods such as roasting, steaming, boiling, and frying according to a method of supplying a heat to a cooking target material. The cooking methods have each merits and defects and thus are selected according to a purpose of cooking. Roasting is a method of directly heating a solid cooking material and can sustain flavor of a material and make a material to be dense, and is advantageous for smoking. However, when roasting a material having no moisture or oiliness, the material is apt to be stiff, and as a flame directly operates, a surface of the material is burnt and the material is lost, and a hazardous substance may occur. Steaming is a cooking method of pouring water in a vessel and boiling a material at a predetermined temperature in which water boils. When food is steamed, flavor of a material is melted in water and thus a taste of food may be reduced, and because water is heated together, energy consumption increases, and much cooking time may be required. Further, when a vessel for putting a material or water does not exist, steaming cannot be used.

An example of boiling is a method of manipulating bean curd. A traditional method of manufacturing bean curd uses a method of boiling bean soup in an iron pot. In this case, because the bottom of the iron pot is a high temperature, in order to prevent a material from getting scorched and sticking to the bottom of the iron pot, it is necessary to continuously stir the material, and thus much manpower is necessary, and when putting much water so as to prevent a material from getting scorched and sticking to the bottom of the iron pot, a thermal efficiency of cooking is lowered. However, because the bottom is a high temperature, a taste of bean curd is excellent. Nowadays, when manufacturing bean curd, a material is cooked using vapor generated in a boiler, and a thermal efficiency is higher than that of a conventional method, but flavor is deteriorated due to low temperature cooking. Therefore, a method of making both a thermal efficiency and flavor to be good is requested.

A heating cooking method is classified into an oven cooking method, a microwave oven heating method, and a vessel heating method according to a heating device. The heating device has a close relationship with a cooking environment and a thermal efficiency of cooking. In the microwave oven heating method, micro electromagnetic waves vibrate water or fat within a material resonating with the electromagnetic waves and thus food itself occurs a heat, whereby cooking is quick, and a thermal efficiency is high. In a method of putting a material within a vessel and heating the vessel at the outside, because insulation or sealing of the vessel cannot be effectively performed, much fuel cost is required and a temperature and humidity within a kitchen is apt to rise. Particularly, in summer, this method may make worse and inconvenient a cooking environment of a home or a kitchen in which cooking is performed.

When cooking food, by generating smoke together with a heat as well as simply providing a heat, a smoking or smoky aroma method of permeating an aroma included in smoke to food may be used.

In barbecue cooking, which is a kind of a roasting method, by burning a material such as an oak tree having an aroma, a heat and smoke including an aroma are applied to a surface of a cooking target material. However, because the method is difficult to adjust a heat, it is apt to burn a material surface, and an aroma is focused on only a surface of the material. Further, in barbecue cooking, because combustion is performed by outside heating in an opened environment, most of a heat generating in combustion of fuel is not used for cooking and emitted and thus a thermal efficiency is low. Further, because heating is performed only in a lower side of a material, when the material is not turned over, there is a problem that the lower side of the material burns and the upside of the material is not cooked. Therefore, when cooking with a barbecue method, a material may be entirely and approximately cooked using another method and cooking may be complete with the barbecue method.

### SUMMARY OF THE INVENTION

The present invention has been made in view of the above problems of a conventional heating and smoking cooking method, and provides a method and device for cooking food and food manufactured using the method that can enhance a heat use rate and a cooking speed and can save energy, compared with a conventional food cooking method and that can simultaneously and directly perform heating and smoking in a process of processing a liquid material and a half liquid material.

In a method of cooking food according to the present invention for achieving the object, a combustion chamber and a cooking vessel are separated by a separation surface having micro holes or slits, and in a state in which the combustion chamber is separated from atmosphere, by burning a material emitting fuel or aroma in the combustion chamber, a combustion gas having a heat and aroma transfers a heat and an aroma to food while being discharged to the outside via food of the cooking vessel.

In a method of cooking food of the present invention, food may be a liquid (including a state in which solids are mixed or sunk in liquid, as in boiling rice) or a half liquid such as paste. In this case, by a pressure of the combustion chamber or by other reasons, the separation surface is formed to enable food not to be moved from the cooking vessel to the combustion chamber but enable a combustion gas of a high temperature including an aroma to move from the combustion chamber to the cooking vessel. In order to perform such operation, the separation surface may basically have micro holes or slits. In order to increase a pressure within the combustion chamber, separately from a fuel gas, compressed air can be supplied from the outside to the combustion chamber through an air blowing means.

A cooking device appropriate for a cooking method of the present invention includes: a cooking vessel for forming space in which a cooking object can be injected and loaded; and a combustion chamber for forming space separated from the outside by a combustion chamber wall, wherein the space of the cooking vessel and the space of the combustion chamber are separated by a separation surface having micro holes or micro slits, and a gas obtained through combustion within the combustion chamber is discharged to the outside of the space of the cooking vessel via the space of the cooking vessel through the separation surface.

In an exemplary embodiment of the present invention, in a cooking device, a main body having a H-shaped vertical section is connected to the bottom by packing, and a combustion device such as a separate separated cooking stove is provided on the bottom. Further, a water ejecting nozzle may be installed at a periphery of packing in order to block a radiation heat for damage prevention of packing by a high temperature of the inside of the combustion chamber and for temperature drop of the combustion chamber and for prevention of increase of an outside temperature. When water is sprayed through a nozzle and a temperature is lowered by absorbing an evaporation heat of water, as a gas of an excessive high temperature entered to the cooking vessel directly contacts with cooked food, a problem of food cooking that carbonize and rancidifies food can be prevented. In the cooking vessel, an air inhalation device may be installed in a lid portion of the upside of food. When the cooking device is used, even if a pressure within the combustion chamber is reduced by applying a negative pressure into the cooking vessel, the air inhalation device can prevent liquid food within the cooking vessel from being discharged downward through a separation surface.

The food cooking vessel may be a pressure vessel for sustaining an internal pressure higher than an atmospheric pressure. However, when an internal pressure of the cooking vessel is too high, a combustion gas having a smoky aroma is difficult to be injected toward the cooking vessel through a separation surface. Therefore, a pressure limitation element such as a pressure detection nozzle for limiting an internal pressure of the cooking vessel may be provided in the cooking device.

Food of the present invention may include bean curd. Bean curd is manufactured by applying water to a pulverized material of bean (including both soybean flour, which is a pulverized material of a dry state of beans and bean paste, which is a pulverized material of a hydrated state), making bean soup, heating the bean soup, and applying salt water (mixture of magnesium chloride and magnesium sulfide) for causing salting-out of an ingredient that can be made into solids to the heated bean soup. A heating process in this cooking process can be performed over a several numbers in different temperature ranges, and bean curd is manufactured using a food cooking method of the present invention.

In bean curd manufactured in this method, because a smoky aroma by smoking is included in entire bean soup in a heating process, after slating-out is performed, a smoky aroma uniformly exists in entire bean curd as well as a surface of bean soup obtained through a process of hardening.

According to the present invention, food can be cooked with a batch method in an amount unit of a vessel, but by installing an inlet and an outlet in the vessel, food may be cooked with a continuous method or with a flow method.

According to the present invention, a thermal efficiency can be improved, compared with a conventional food cooking method and device. Further, because heating and smoking can be simultaneously and directly executed in a process of processing a liquid material or a half liquid material, a cooking method is simple and convenient.

Further, according to the present invention, because a heated combustion gas directly contacts with food and heating cooking is performed, high temperature cooking can be performed and thus an aroma of food itself is directly sustained, flavor can be improved and a smoky aroma is distributed to the inside of entire food as well as an outside surface thereof and thus flavor by a smoky aroma can be enhanced.

According to the present invention, as a thermal efficiency improves in cooking, an energy cost can be reduced and a cooking speed can be improved, and when a cooking speed increases, a quantity of food that can process with one equipment increases and thus the installation number of equipments reduces, an area due to equipment installation can be reduced, and an equipment cost can be reduced.

The cooking device of the present invention suppresses a radiation or a conduction heat from escaping to the outside. Therefore, because it is possible to work near the cooking device, space necessary for cooking can be reduced. By improving a cooking environment by lowering a peripheral temperature, an environment for an elegant work can be provided to cooks of a kitchen. According to decrease of cooking space, a rent cost can be reduced. Further, by suppressing proliferation of microorganism due to a temperature decline within the cooking device, food poisoning can be prevented.

Particularly, by using when manufacturing food such as bean curd, flavor of food can be improved, bean curd contributes to consumption pattern formation that replaces consumption of flesh and meat, and thus environment burden according to consumption increase of flesh and meat can be relieved.

### BRIEF DESCRIPTION OF THE DRAWINGS

FIG. 1 is a conceptual diagram illustrating a cooking device appropriate for performing a method according to an exemplary embodiment of the present invention;

FIG. 2 is a top plan view illustrating a separation surface of the cooking device of FIG. 1; and

FIGS. 3 to 5 each are cross-sectional views illustrating a food cooking device according to other exemplary embodiments of the present invention.

### DETAILED DESCRIPTION OF THE INVENTION

Hereinafter, an exemplary embodiment of the present invention will be described in detail.

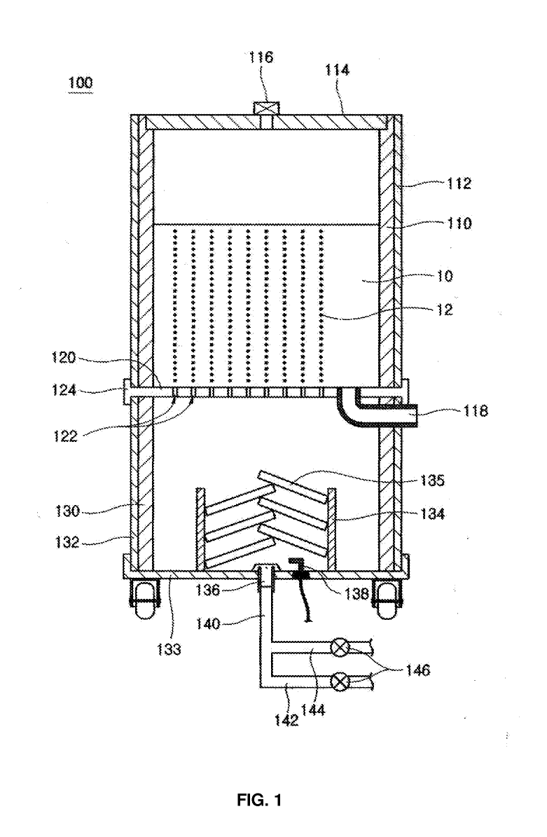

Referring to FIG. 1, a vessel formed in an approximately cylindrical shape in a cooking device 100 is partitioned by a separation surface 120 crossing a cylinder in the center. The separation surface 120 has a plurality of micro slits or holes 122. A lower wall of the cooking device partitioned by the separation surface 120 forms a combustion chamber 130, and an upper wall of the cooking device forms a cooking vessel 110.

Food (material) to be a cooking target is filled in the cooking vessel 110, and fuel supplied to the combustion chamber is burnt in the combustion chamber 130. The combustion chamber 130 is formed with an opening and closing method in which a wall and a bottom 133 are separated. Therefore, the combustion chamber can be opened to supply firewood for smoking, and when combustion for cooking is performed, the combustion chamber 130 is closed from outside air. A brazier 134 is installed in the combustion chamber, and firewood 135 is prepared as a combustion material for emitting a smoky aroma for smoking in the brazier 134. In the brazier 134, a gas supply nozzle 136 for supplying gas for igniting the firewood 135 and an igniter 138 for generating a spark for ignition of gas fire are installed. Gas fire is used for ignition of firewood and may become a means for supplying a heat for cooking food. For combustion of wood or gas, which is a combustion material, air is injected by a air blower from the outside to the brazier 134. An air pressure by the air blower prevents liquid food from being injected from the cooking vessel 110 to the combustion chamber 130 and enables a combustion gas together with a smoky aroma to be easily injected into the cooking vessel 110.

In a cooking process of a cooking device having such a structure, for example, while some wall of the combustion chamber 130 is separated from the bottom 133, the combustion chamber 130 is opened, the firewood 135 is installed in the brazier 134, and after the combustion chamber 130 is closed again, outside air is injected to the combustion chamber 130 by a air blower 146. As a pressure of the combustion chamber becomes higher than an atmospheric pressure by outside air, a food (material) 10 is supplied to the cooking vessel 110. While firewood is burnt with ignition, a heated combustion gas including a smoky aroma occurs. A combustion gas including a smoky aroma operates in food through the separation surface. In this case, a combustion gas contacts with the food 10 in a form of a plurality of micro bubbles 12, and a heat of a combustion gas and a smoky aroma ingredient are transferred through an interface of bubbles and the food 10. A heat may be transferred to the food 10 in a conduction method through the separation surface 120 or the cooking vessel 110.

In the present exemplary embodiment, food is bean soup in which bean-curd refuse is removed or bean soup having bean-curd refuse. In a heating process, when a combustion gas of firewood in a high temperature state passes through bean soup together with a smoky aroma, micro bubbles occur within bean soup due to the micro holes 122 or slits of the separation surface.

Heated bean soup, having received a smoky aroma ingredient is inhaled into an inhalation pipe (not shown) for absorbing bean soup and is transferred to a separate vessel for operating salt water or other coagulating agents for solidification, or is discharged by an outlet of a lower end of the cooking vessel and moves to a separate vessel (not shown). In order to easily perform discharge, the bottom of the cooking vessel 110 that may include the separation surface 120 is inclined, an outlet 118 is installed at a lowest portion of the bottom, and a pipe is connected to the outlet 118 and is connected to the separate vessel. Alternatively, instead of an inhalation pipe, bean soup may be manually transferred with a scoop. In the separate vessel, by injecting a common coagulating agent such as salt water (mixture of magnesium chloride and magnesium sulfate), calcium chloride, calcium sulfate, or gluconolactone, protein within bean soup is coagulated. In this case, because a smoky aroma ingredient is uniformly dispersed in bean soup, solids such as protein are coagulated in bean soup and thus a smoky aroma ingredient is uniformly dispersed in hard bean curd.

In the foregoing exemplary embodiment, bean curd cooked in a liquid phase and hardened in a solid phase is exemplified, but a method of cooking food according to an exemplary embodiment of the present invention can be used for improving flavor and removing disagreeable smells by directly adding a smoky aroma to paste type food such as starch gel and curry, food in which solids are mixed to a liquid material or a half liquid material, or a liquid material such as gravy. Therefore, the cooking device according to an exemplary embodiment of the present invention can be used for rice boiling of a form in which grain of rice sinks or floats in water while cooking.

In the cooking device of the present invention, an additional device such as an automatic agitator may be further provided according to a form characteristic of a cooking object within a cooking vessel, as needed.

In the cooking device of the present invention, an insulation material layer 112 is covered at an outer side surface of a portion of the cooking vessel 110 through a cover form, a coating form, or other installation methods. The insulation material layer 112 performs a function of increasing a thermal efficiency of heating and cooking food by suppressing a heat of the cooking vessel 110 from being emitted to the outside, and because a cook directly touches an outer side surface of the cooking vessel 110 with a hand, the insulation material layer 112 performs a function of reducing a danger of a burn and easily handling the cooking vessel.

By installing an insulation layer 132 in the inside or the outside of the combustion chamber 130 as well as the cooking vessel 110, heat damage through heat conduction in the combustion chamber wall upon heating cooking can be reduced.

The brazier 134 that may put the firewood 135 is integrally installed in the bottom 133 of the combustion chamber 130. The bottom 133 becomes a portion of the wall forming the entire combustion chamber. The gas supply nozzle 136 and the igniter 138 that can supply gas and air to the brazier 134 are installed in the bottom 133. An end portion of an integrated pipe 140 in which a gas pipe 142 and an air pipe 144 are integrated is connected to the gas supply nozzle 136 through an outside pipe connection inlet of the combustion chamber wall. The igniter 138 is generally an electric spark generator and is connected by an electric wire to a handle (not shown) of an electric spark generator existing at the outside.

Therefore, when an outside pipe of gas and air and an outside pipe connection inlet are separated, the cooking device can be simply moved. For moving, a wheel may be installed at the bottom of the combustion chamber.

The combustion chamber 130 is made of a material that can withstand a heat and corrosion by a flame or a combustion gas, may be made of a ceramic material, but may be formed with a metal plate having an excellent workability. Further, the combustion chamber may be made of the same material as that of the cooking vessel 110 but may be separately made of a separate material.

In the present exemplary embodiment, the combustion chamber 130 and the cooking vessel 110 are coupled to the separation surface 120 with a sleeve method through a socket 124 of the separation surface 120. An upper lid 114 is provided in the cooking vessel 110, and a gas release nozzle 116 that can be also used as a pressure sensor for discharging an inside gas to the outside by operating when an internal pressure is a predetermined level or more is installed in the upper lid 114.

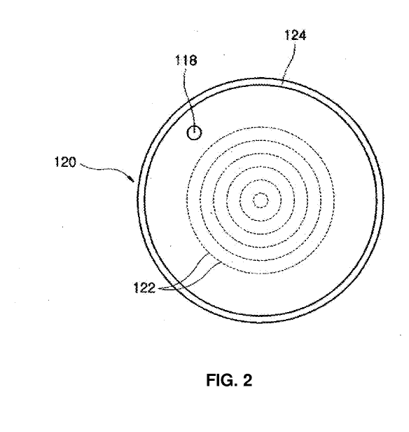

Referring to FIG. 2, the micro holes 122 or slits of the separation surface 120 for partitioning the combustion chamber and the cooking vessel may be formed in a thin metal plate by a chemical method such as etching or a physical method such as punching or laser radiation. Alternatively, the separation surface 120 may be formed with a method of overlapping or densely and adjacently winding metal belts (plate material that can be easily bent due to a long length and having a small thickness and a limited width; bend) or metal fibers in a frame for a predetermined form, or with a method of covering a frame with metal fabric. The separation surface 120 may be formed by disposing metal belts (bands) or metal fibers in parallel and welding metal bands or metal fibers at a predetermined gap in a length direction and in a direction intersecting a length direction and by coupling metal bands or metal fibers and by using a gap of metal bands or metal fibers in which welding is not performed as a slit and by cutting in a necessary form. Particularly, when densely winding metal belts or metal fibers, in order to sustain the metal belt or the metal fiber in a stable state, some or all of a portion contacting with the frame may be fixed by welding. The metal belt or the metal fiber may be densely wound one time, but may be wound to overlap with a plurality of times. In order to prevent a motion, metal belts or metal fibers may be sparsely welded.

In the separation film 120, the outlet 118 is formed to discharge heating cooked food to the outside, and reference numeral 124 indicates a socket.

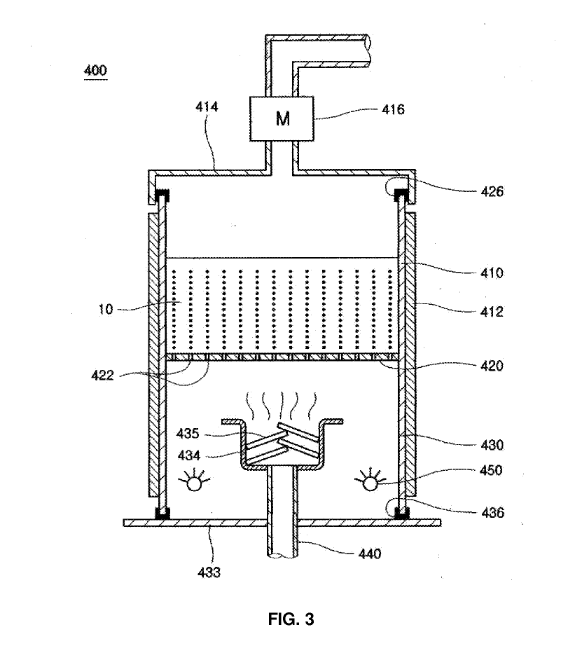

A cooking device of an exemplary embodiment described with reference to FIG. 3 has an entirely similar structure as that of the exemplary embodiment described with reference to FIG. 1, but in the present exemplary embodiment, the cooking device has a cylinder type wall. At the intermediate of the cylinder type wall, a separation surface 420 that partitions an upper part 410 and a lower part 430 by crossing the cylinder and that has many micro holes or micro slits is formed integrally with the cylinder type wall. In this case, the upper part 410 of the cylinder type wall forms a cooking vessel, and the lower part 430 forms the combustion chamber. The cylinder type wall forms a main body having an entirely H-shaped vertical section together with the separation surface. A lower end of the cylinder type wall is detachably coupled to a bottom 433 forming a part of the combustion chamber, and a coupling portion sustains a seal state by lower packing 436. At an upper part of the bottom 433, a combustion device such as a brazier 434 separately separated from the bottom 433 is installed. When the bottom 433 and the brazier 434 are separated in this way, if fuel such as wood 435 is burnt at the inside, heat emission to the outside through the bottom 433 is suppressed. A air blowing pipe 440 is connected to a lower part of the brazier 434. The air blowing pipe supplies external air for combustion to the brazier and prevents food from being injected to the combustion chamber through a separation surface upon cooking by raising an internal pressure of the combustion chamber. The air blowing pipe 440 is connected to an external air blower (not shown) by passing through the bottom 433.

Upper packing 426 is installed at an upper end portion of the upper part 410 of the cylinder type wall, and a lid 414 of the cooking vessel is detachably coupled to the upper part 410. The cooking vessel may be sealed from the outside due to the upper packing 426. A hole is formed in the lid 414 and is connected to an end portion of an inhalation pipe of a air blower 416 as an air inhalation device. When the air blower 416 of the air inhalation device is driven, while vapor within the cooking vessel and a combustion chamber gas passing through the cooking vessel are discharged, the inside of the cooking vessel is in a negative pressure state. Therefore, liquid food within the cooking vessel is prevented from being discharged downward through the separation surface. Such a structure is appropriate particularly when a pressure of the air blower that increases an internal pressure is not transferred to the combustion chamber and may be limitedly used when air of the air blower is not supplied to the combustion chamber or when combustion is not performed in the combustion chamber can be used while moving the cooking device.

The lower packing 436 sealing while connecting the lower part 430 and the bottom 433 of the cylinder type wall is made of silicon rubber strong on heat. However, because a temperature within the combustion chamber is very high, the packing may be damaged by a heat. A water ejecting nozzle 450 as a means for preventing the packing from being damaged by a heat is installed at a periphery (the upside of the packing between the brazier and the combustion chamber wall is appropriate) of an internal packing of the combustion chamber. When water is sprayed in an aerosol form through the nozzle, the sprayed water absorbs an evaporation heat when being vapor while being evaporated and thus lowers a peripheral temperature. However, water sprayed from the nozzle disturbs combustion in the brazier and prevents incomplete combustion. When the water participle nozzle is installed in this way, a temperature of gas entered to the cooking vessel through the separation surface 420 is lowered and thus a cooking problem that a high temperature gas carbonizes and acidifies food while directly contacting with food can be solved. Therefore, the water ejecting nozzle may be used even in the exemplary embodiment of FIG. 1 in which the packing is not installed.

At the outside of the cylinder type wall, an insulation coat 412 for heating and insulating is installed to prevent a thermal efficiency from being dropped as a heat of the cooking vessel or the combustion chamber is emitted to the outside. When the insulation coat 412 is installed, even if the cooking vessel or the combustion chamber is in a high temperature, a cook can move food within the cooking vessel by holding the cooking vessel at the outside of the insulation coat and separating a cooking device body from the bottom.

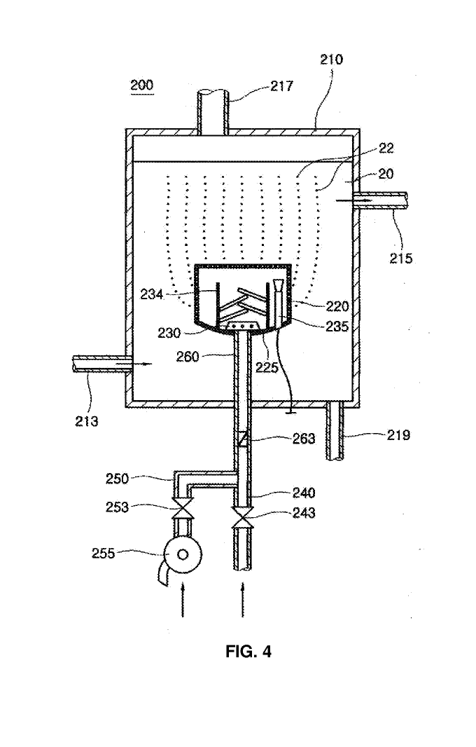

In a cooking device according to an exemplary embodiment described with reference to FIG. 4, a combustion chamber 220 is positioned within a cooking vessel 210. The wall itself forming the combustion chamber partitions the cooking vessel 210 and the combustion chamber 220, and micro holes or slits are formed in a considerable portion of the combustion chamber wall and form a separation surface.

At an upper end portion of the cooking vessel 210, a gas outlet 217 for collecting a gas ingredient such as vapor and bubbles 22 discharged via liquid food 20 and discharging the gas ingredient to the outside is installed, and a food outlet is formed in an upper side wall of the cooking vessel 210, and heated liquid food is discharged along a pipe 215 connected to the food outlet. A food inlet is formed in a lower side wall of the cooking vessel, and a pipe 213 that can supply a liquid food material to the cooking vessel is connected to the inlet.

Most of the wall of the cooking vessel 210 contacts with the liquid food 20, and it is unnecessary that the wall of the cooking vessel 210 directly contacts with a wall of the combustion chamber 220 of a high temperature within the cooking device. Therefore, in consideration of a temperature and chemical characteristic of the normally heated food 20, the wall of the cooking vessel is made of a material having corrosion resistance and heat resistance or is formed by coating with such a material. In order to prevent heat leakage to the outside, an outer surface of the cooking vessel wall may be enclosed with an insulation material (not shown). As a food material contacts with the cooking vessel, it is preferable that a material that may emit a poisonous material is not used as a material of the cooking vessel.

The cooking vessel 210 is formed to partition inside space and outside space, but a portion of the wall may be formed to open or close or to assemble for convenient maintenance. Most of inside space of the cooking vessel 210 is filled with food (material). Food may have a continuous flow to be injected into and discharged from the cooking vessel with a predetermined amount in a predetermined time rate. A predetermined amount of food may be injected and heated and then be discharged in a bundle through the outlet, as needed. A drain 219 is formed in the bottom of the cooking vessel 210 and removes all remaining food of the cooking vessel 210, and the combustion chamber may be exposed in the cooking device.

A bottom 225, a side wall, and a top surface of the combustion chamber wall entirely form a separation film for partitioning the inside and the outside of the combustion chamber. At the bottom of the intermediate of the combustion chamber wall, a pipe 260 for supplying a fuel gas and air to the combustion chamber is connected, and an igniter 235 that may cause an electric spark and a brazier 234 that may put a material for emitting an aroma are installed. A plurality of micro holes or micro slots are formed in other portions (side surface and top surface) of the combustion chamber wall. Because holes or slots are formed in the combustion chamber wall, the combustion chamber is not sealed by the wall, but the combustion chamber wall largely separates the inside space and outside space of the combustion chamber. The bottom and other portions (side wall and top surface) are separated to open and close the combustion chamber, and when the combustion chamber is opened, a material (firewood) that may emit an aroma may be loaded in the brazier 234.

In the present exemplary embodiment, a fuel gas pipe and an air pipe form the integrated supply pipe 260, and the supply pipe is fixed to the wall of the cooking vessel 210 and the wall of the combustion chamber while passing through the wall of the cooking vessel 210 and the wall 220 of the combustion chamber. Therefore, the fuel and air integrated supply pipe 260 performs a function of fixing to position the combustion chamber in a state separated from the cooking vessel wall at space within the cooking vessel 210. The walls and the fuel and air supply pipe may be fixed using screw fastening (a silicon gasket may be generally used for airtight) by a volt or using a mortar material or welding.

In the present exemplary embodiment, the fuel and air integrated supply pipe 260 is integrated into one and is introduced to the combustion chamber, but a fuel supply pipe and an air supply pipe may be separately introduced to the combustion chamber and be connected to the brazier. While operating the brazier 234, a pressure within the combustion chamber should be sustained higher than that within the cooking vessel, and a supply pressure of fuel and air for supplying fuel or air should be higher than a pressure within the combustion chamber. For this purpose, a air blower 255 may be installed in the integrated pipe or in each of a fuel pipe and an air pipe, and valves 243 and 253 for adjusting opening and closing are installed in the pipe.

Because holes or slots of the combustion chamber wall are minute, the combustion chamber wall performs a function of a filter, and thus when fuel of the brazier is burnt in the combustion chamber, most of ashes or soot is prevented from being directly injected into a food material.

Although not shown in the present exemplary embodiment, instead of directly using firewood (tree) as a combustion material for emitting a smoke aroma within the combustion chamber, a smoky aroma refined liquid obtained by distilling an effective ingredient of a pyroligneous liquid may be prepared in a heating vessel. In order to heat food and the heating vessel, instead of the brazier 234, only a burner 230 having an igniter and a nozzle connected to an outer gas supply source may be prepared. In this case, it is preferable that a flame of the burner 230 within the combustion chamber is relatively weak and is generally uniformly distributed and thus a flame does not directly contact with the combustion chamber wall.

At this time, because a combustion gas directly contacts with food, a gas that hardly generates a noxious material other than vapor and carbon dioxide because perfect combustion can be easily performed, such as methane or hydrogen may be used as a combustion material. Because the burner can remove a problem according to formation of a flame, it is preferable to use no flame burner that can reduce combustion space and that can increase a combustion efficiency.

In such a cooking device, cooking may be performed in the following example. When the cooking vessel is empty, by opening the combustion chamber, a material that may emit an aroma is mounted and the combustion chamber is closed. Air is injected into the combustion chamber by the air blower, liquid food is supplied through an inlet of the cooking vessel, and food is prevented from being injected into the combustion chamber. When a food material is supplied, while an igniter operates in the combustion chamber, a fuel gas is supplied, and when combustion is performed, a combustion gas of a high temperature having a smoky aroma is discharged to outside atmosphere through the cooking vessel while contacting with food within the cooking vessel in a micro bubble form through micro holes or slits of a separation surface.

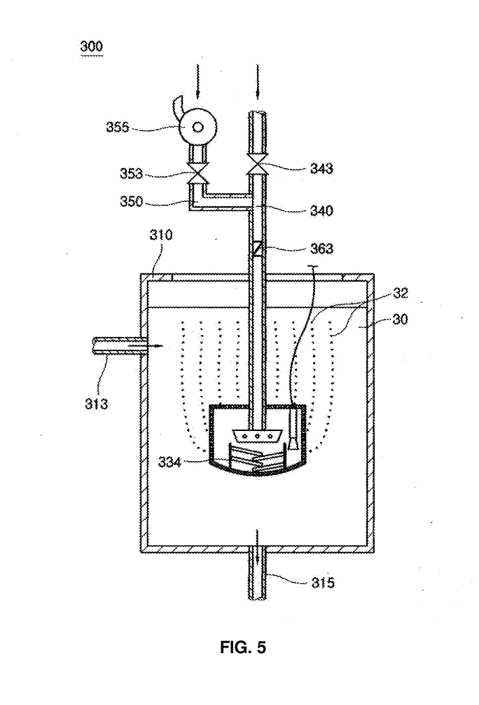

In an exemplary embodiment of FIG. 5, at a top surface of the cooking vessel, a lid portion opened but detachably coupled in a sealed type exists, and in the lid portion, when an internal pressure of the cooking vessel becomes a predetermined pressure higher than an atmospheric pressure, a discharge nozzle that can be also used as a pressure detection sensor for discharging an internal gas to the outside is installed. When an internal pressure of the cooking vessel is adjusted to an atmospheric pressure or more, an efficiency of heating cooking is improved and a smoking efficiency is improved, and a pressure of the discharge nozzle that can be also used as a pressure detection sensor can prevent the cooking vessel from being in a dangerous state as an internal pressure of the cooking vessel is too high.

In the above cooking devices, when a cooking target food material is a liquid, a pressure of a combustion gas within the combustion chamber by combustion of fuel becomes larger than a largest value (a pressure operating in a slot or a hole of the lowermost side) of pressures by a food material applied to the combustion chamber wall in a normal operation state. In this case, a pressure within the combustion chamber is basically affected by an injection amount of fuel and oxygen (air) per time and an inner temperature, but may be substantially affected by a sectional area and the number of micro holes or micro slots formed in a separation surface forming a portion of the combustion chamber. When a sectional area of holes or slots is large, a pressure in entire holes or slots is not constant and thus the combustion chamber may shake, and in order to prevent a liquid food material from being injected into the combustion chamber, a quantity of the combustion gas should be adjusted to sustain an atmosphere pressure within the combustion chamber to be larger than a pressure by a food material. In consideration of a cooking object, when an amount of the combustion gas becomes a lot, a heat exchange is not fully performed and the combustion gas may be discharged while having much heat. Further, in order to increase an efficiency of a heat exchange by increasing a contact area per bulk, it is preferable that a diameter of bubbles within liquid food by a combustion gas is small and thus it is preferable that a sectional area of holes or slots having an influence on a size of bubbles is small. When many cooking objects exist, if a size of slots or holes is too small, a thermal efficiency is good, but a processing capacity decreases, and in order to make a thermal efficiency to be good, it is preferable to uniformly distribute bubbles in liquid and thus holes or slots of the wall are uniformly distributed in consideration of a form or a size of the cooking vessel.

The combustion chamber exists at the lower side of the cooking vessel, and as the cooking vessel has a deep depth, there is an advantage that a time increases in which bubbles perform a heat exchange within a liquid cooking object. Bubbles perform a function of raising a cooking object upward by a friction with the cooking object while rising by a density difference, and an entire cooking object more easily convects by a motion of the cooking object and thus there is an advantage that it is unnecessary to stir the cooking object while heating.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method of cooking food, the method comprising:
injecting a cooking object into a cooking vessel of a cooking device in which a combustion chamber and the cooking vessel are separated by a separation surface having micro holes or slits; and
making a combustion gas having a heat and aroma discharge to the outside via inside space of the cooking vessel through the separation surface by burning a material emitting an aroma in the combustion chamber in a state in which the combustion chamber is separated from atmosphere.

2. The method of claim 1, wherein the cooking vessel is formed as a pressure vessel in order to make an internal pressure of the cooking vessel to be higher than a peripheral atmospheric pressure of the cooking device, and
at the burning of a material, only when the internal pressure of the cooking vessel is a predetermined pressure or more, the combustion gas is discharged to the outside.

3. The method of claim 1, wherein the material emitting the aroma is wood.

4. The method of claim 1, wherein the cooking object is made of a liquid material or a half liquid material, and
at the burning of a material, a pressure of the inside of the combustion chamber is adjusted to prevent the cooking object from being injected into the combustion chamber through the separation surface by a pressure difference between the inside of the combustion chamber and the inside of the cooking vessel.

5. The method of claim 4, wherein the cooking object is bean soup comprising a bean pulverized material and water.

6. The method of claim 1, further comprising injection preparing step of forming a pressure higher than that of the inside of the cooking vessel by increasing an internal pressure of the combustion chamber before the injecting of a cooking object.

7. The method of claim 4, further comprising injection preparing step of forming a pressure higher than that of the inside of the cooking vessel by increasing an internal pressure of the combustion chamber before the injecting of a cooking object.

8. Smoked food in which a smoky aroma ingredient is uniformly dispersed to the inside as well as the outside thereof and comprising one of bean curd, boiled rice, and starch gel.

9. A cooking device comprising:
a cooking vessel for forming space in which a cooking object can be injected and loaded; and
a combustion chamber for forming space separated from the outside by a combustion chamber wall,
wherein the space of the cooking vessel and the space of the combustion chamber are separated by a separation surface having micro holes or micro slits, and are formed so that a gas obtained through combustion within the combustion chamber may be discharged to the outside of the space of the cooking vessel via the space of the cooking vessel through the separation surface.

10. The cooking device of claim 9, wherein the cooking object comprises a liquid cooking object, and in order to prevent the liquid cooking object from being injected into the combustion chamber through the separation surface, a size of the micro hole or the micro slit and a pressure within the combustion chamber and the cooking vessel are adjusted.

11. The cooking device of claim 9, wherein an insulation material layer is installed at the outside of the cooking vessel.

12. The cooking device of claim 9, wherein the cooking vessel has an inlet coupled to a pipe in order to inject the liquid cooking object and an outlet coupled to a pipe in order to discharge the liquid cooking object.

13. The cooking device of claim 9, wherein the cooking vessel has an opening that can be hermitically coupled to a lid from the outside, and the cooking vessel is connected to an air inhalation device in order to apply a negative pressure to the inside.

14. The cooking device of claim 9, wherein the combustion chamber comprises a brazier formed to burn a wood as fuel or a vessel for putting a smoky aroma refined liquid and an igniter and a gas nozzle connected to an outside gas supply source.

15. The cooking device of claim 9, wherein at the inside of the combustion chamber, a water ejecting nozzle is installed between the brazier and the combustion chamber wall.

16. The cooking device of claim 9, wherein the cooking vessel and the combustion chamber are formed with upper space and lower space partitioned by installing the separation surface to cross the cylinder type wall at the intermediate of the cylinder type wall, the cylinder type wall and the separation surface form a H-shaped vertical section, and a lower part of the cylinder type wall is connected to the bottom forming a part of the combustion chamber while sustaining seal using packing and thus the combustion chamber is separated from the outside.

17. The cooking device of claim 10, wherein an insulation material layer is installed at the outside of the cooking vessel.

18. The cooking device of claim 10, wherein the cooking vessel has an inlet coupled to a pipe in order to inject the liquid cooking object and an outlet coupled to a pipe in order to discharge the liquid cooking object.

19. The cooking device of claim 10, wherein the cooking vessel has an opening that can be hermitically coupled to a lid from the outside, and the cooking vessel is connected to an air inhalation device in order to apply a negative pressure to the inside.

20. The cooking device of claim 10, wherein the combustion chamber comprises a brazier formed to burn a wood as fuel or a vessel for putting a smoky aroma refined liquid and an igniter and a gas nozzle connected to an outside gas supply source.
